(19) United States
(12) Patent Application Publication
(10) Pub. No.: US 2024/0429406 A1
(43) Pub. Date: Dec. 26, 2024

(54) METHOD FOR MANUFACTURING PP/CA SEPARATOR, AND BATTERY USING SEPARATOR

(71) Applicant: INNO EN INC., Hwaseong-si (KR)

(72) Inventors: Sang Wook KANG, Seoul (KR); Yong Hak PARK, Seoul (KR)

(21) Appl. No.: 18/826,556

(22) Filed: Sep. 6, 2024

Related U.S. Application Data
(63) Continuation of application No. PCT/KR2022/003779, filed on Mar. 17, 2022.

(30) Foreign Application Priority Data
Mar. 11, 2022 (KR) 10-2022-0030689

(51) Int. Cl. H01M 8/0239; H01M 8/0245; H01M 8/16

(52) U.S. Cl. CPC H01M 8/0239; H01M 8/0245; H01M 8/16

(57) ABSTRACT

Proposed is a double-layer separator composed of polypropylene (PP) and cellulose acetate (CA), wherein a PP film is coated with a CA mixed solution containing a plasticizer, thus forming pores in a CA film through water pressure treatment. When the separator is applied as a separator for a battery, the thermal stability and mechanical stability of the separator enable a battery having thermal stability and long-term usability to be implemented.

### CROSS-REFERENCE TO RELATED APPLICATION

This application is a continuation application of the International Application PCT/KR2022/003779, filed on Mar. 17, 2022, which is incorporated herein by reference in its entirety, and additionally claims priority from Korean Patent Application No. 10-2022-0030689, filed on Mar. 11, 2022, which is also incorporated herein by reference in its entirety.

### TECHNICAL FIELD

The present disclosure relates to technology for a polypropylene (PP)-based separator (membrane), the PP-based separator being a porous separator having a double structure in which two porous films, specifically a PP film and a cellulose acetate (CA) film, are bonded using a plasticizer and water pressure treatment for pore formation in CA.

### BACKGROUND ART

As one way of solving various energy-related issues regarding energy conservation/supply/demand, including environmental pollution and energy depletion issues, lithium-ion batteries (LIBs) have been applied to a variety of technological fields such as energy storage technology, mobile electronics, and electric vehicles, exhibiting much better electrical properties than existing secondary batteries. The recently raised bar on environmental regulations by many countries has led to the expectation that the market for lithium-ion secondary batteries will grow even further. However, despite the high value of LIBs, fire-related issues are highlighted as the biggest drawback. In particular, while separators in LIBs must not only maintain thermal and mechanical stability but also maintain high porosity and ionic conductivity, a separator interposed between electrodes plays a significantly important role in protecting both electrodes from catching fire caused by external shock or shorts.

When looking into recent trends regarding LIB separators, highly stable polyimide-based materials have attracted attention as polymeric separator materials and are also widely available commercially. However, such polyimide-based materials are relatively expensive, and thus research on cheaper and more efficient materials is still in progress.

Zhao et al. published a research result showing that through organic/inorganic hybrid cross-linking, the thermal stability of commercially available olefin separators is likely to increase. The above research showed that the cross-linking of silicon and oxygen increased the thermal stability and provided adhesive strength between films. Additionally, using porous Al₂O₃/polyvinylidene fluoride (PVDF)-coated separators to complement the performance of Li—S batteries, Zhang et al. published the result showing that the structure of the Al₂O₃/PVDF-coated separator promoted the mobility of lithium ions, and the reversible capacity was significantly high even after 50 cycles.

Furthermore, Liu et al. published a research result showing that a SiO₂/polyacrylamide (PAM)-grafted PP separator exhibits excellent thermal stability and electrochemical performance through surface chemical modification. The separator of the above research exhibited a high-temperature shrinkage rate at a level lower than that of the high-temperature shrinkage rate of typical PP separators. It has been reported that the above separator improves the cycle performance and stability of batteries. Additionally, Liu et al. used active silicon nanoparticles to support graphene uniformly. In this research, due to three-dimensional network formation and strong intermolecular interactions, it has been reported that this method enables highly stable batteries to be manufactured. It has also been reported in this research that the initial efficiency increases to 93.2%, and the capacity retention rate is excellent at high current density even after 100 cycles.

### DISCLOSURE

### Technical Problem

The present disclosure aims to provide technology for manufacturing a novel PP-based separator having improved mechanical, thermal, and electrical properties compared to existing PP-based separators and technology for a battery using the same.

In particular, the present disclosure aims to provide a separator having excellent thermal and mechanical stability through a double-layer separator composed of a PP film and a CA film.

In particular, the present disclosure aims to provide technology for forming a pore channel penetrating a PP film and a CA film.

### Technical Solution

The present disclosure provides a method of manufacturing a PP/CA separator having a double-layer structure and including a PP film and a CA film, the method including the following steps: preparing a porous PP film; manufacturing a PP/CA separator by coating and drying an upper portion of the porous PP film with a mixed solution including CA, a plasticizer, and a solvent at least once; and forming a pore channel penetrating the PP and CA films layer by applying water pressure to the PP/CA separator through water pressure treatment.

In particular, the plasticizer may be at least one selected from among glycerin, lactic acid, CaO, glycolic acid, NaCl, NaNO₃, and propylene glycol.

In particular, a molar ratio of CA to the plasticizer in the mixed solution may be in the range of 1:0.001 to 0.3.

In particular, the solvent may be a mixture of two or more solvents.

In particular, the water pressure treatment may be performed in a direction from the PP film to the CA film.

In particular, the water pressure may be in the range of 2 to 20 bar.

Additionally, the present disclosure may also enable a battery to be manufactured using the above PP/CA separator.

In particular, the battery may be a microbial fuel cell (MFC).

### Advantageous Effects

The present disclosure relates to technology for a double-layer PP/CA separator, the separator of the present disclosure being a composite separator having both the physical strength of PP and the thermal stability of CA. When applied to a battery, there are advantages in that the high thermal stability of the separator of the present disclosure reduces the possibility of fire in this battery compared to batteries using existing separators, and electrical properties are unlikely to change even after long-term use.

Additionally, in the present disclosure, the surface of the PP film is allowed to be hydrophilic through the coating of the upper portion of the PP film with the CA film, thus reducing fouling on the surface of the PP film. As a result, the durability of an MFC cell to which the separator of the present disclosure is applied can be improved, which is advantageous.

### DESCRIPTION OF DRAWINGS

FIG. 1 is a schematic view illustrating a method of manufacturing a PP/CA-CaO separator of the present disclosure in the case of using CaO as a plasticizer,

FIG. 2A is a measurement image of the PP-side surface of a PP/CA-lactic acid separator, the measurement image obtained by a scanning electron microscope (SEM), FIG. 2B is an enlarged view of the circle in FIG. 2A, FIG. 2C is an SEM measurement image of the CA-side surface of a PP/CA-lactic acid film, FIG. 2D is an enlarged view of the circle in FIG. 2C, and FIG. 2E is a cross-sectional SEM measurement image of the PP/CA-lactic acid separator,

FIGS. 3A to 3C show experimental results of Fourier-transform infrared spectroscopy (FT-IR) for separators of the present disclosure and comparative examples;

FIGS. 4A and 4B are SEM measurement images of a neat PP film and the PP side of a PP/CA-glycerin separator, respectively;

FIGS. 5A and 5B are SEM measurement images of the surface of a CA-glycerin film before and after water treatment, respectively, and FIG. 5C is an SEM measurement image of the CA side of a PP/CA-glycerin separator;

FIG. 6A shows thermogravimetric analysis (TGA) data on neat PP, neat CA, CA-glycerin (before water pressure treatment), CA-glycerin (water pressure treatment at 8 bar), and a PP/CA-glycerin separator, and FIG. 6B is an enlarged view of FIG. 6A;

FIGS. 7A and 7B show FT-IR experimental results for C—O—C ether groups (in the range of 960 to 1100 cm⁻¹) of neat PP, a CA-glycerin film, and a PP/CA-glycerin separator,

FIGS. 8A and 8B show deconvoluted data on FT-IR measurement results for ether groups (in the range of 960 to 1100 cm⁻¹) of CA-glycerin (water pressure treatment at 8 bar) and a PP/CA-glycerin (water pressure treatment at 8 bar) separator, respectively;

FIGS. 9A and 9B show FT-IR spectra for carbonyl groups (in the range of 1690 to 1780 cm⁻¹) of neat PP, CA-glycerin, and a PP/CA-glycerin separator,

FIGS. 10A and 10B show deconvoluted data on FT-IR spectra for carbonyl groups (in the range of 1690 to 1780 cm⁻¹) of CA-glycerin and a PP/CA-glycerin separator, respectively;

FIGS. 11A, 11B, 11C, and 11D show SEM measurement results of CA-CaO, the CA side of PP/CA-CaO, neat PP, and the PP side of PP/CA-CaO (all samples obtained through water treatment);

FIG. 12 shows TGA experimental results of different samples (neat CA, CA-CaO, CA-CaO after water pressure, PP/CA-CaO after water pressure, and neat PP);

FIGS. 13A to 13C show FT-IR data on carbonyl groups for neat CA, CA-CaO (before water pressure treatment), and CA-CaO (after water pressure treatment) samples, respectively;

FIG. 14A shows FT-IR measurement results of different samples including PP/CA-CaO of the present disclosure, FIG. 14B is a partially enlarged view of ether groups (in the range of 960 to 1100 cm⁻¹), and FIG. 14C is an enlarged view of carbonyl groups (in the range of 1700 to 1800 cm⁻¹);

FIGS. 15A, 15B, and 15C show deconvoluted data on ether groups of CA-CaO, the CA side of PP/CA-CaO, and the PP side of PP/CA-CaO, respectively;

FIGS. 16A, 16B, and 16C show deconvoluted data on carbonyl groups of CA-CaO, the CA side of PP/CA-CaO, and the PP side of PP/CA-CaO, respectively; and

FIG. 17 shows measurement results of MFC voltage.

### MODE FOR INVENTION

The present disclosure provides a method of manufacturing a PP/CA separator having a double-layer structure and including a PP film and a CA film, the method including the following steps: preparing a porous PP film; manufacturing a PP/CA separator by coating and drying an upper portion of the porous PP film with a mixed solution including CA, a plasticizer, and a solvent at least once; and forming a pore channel penetrating the PP and CA films by applying water pressure to the PP/CA separator through water pressure treatment.

In the present disclosure, PP refers to polypropylene, CA refers to cellulose acetate, neat PP refers to a porous separator composed of PP alone, neat CA refers to a film (or separator) composed of CA alone, “PP/CA-lactic acid” refers to a double-layer separator composed of PP and CA, wherein the double-layer separator is manufactured by coating and drying a PP layer with a mixed solution of CA and lactic acid serving as the plasticizer, “PP/CA-glycerin” refers to a double-layer separator composed of PP and CA, wherein the double-layer separator is manufactured using glycerin serving as the plasticizer, and “PP/CA-CaO” refers to a double-layer separator composed of PP and CA, wherein the double-layer separator is manufactured using CaO as the plasticizer. The term “PP/CA” is used in the claims to collectively refer to double-layer separators composed of PP and CA, wherein the double-layer separators are manufactured using different plasticizers described above.

In the present disclosure, the terms “film” and “layer” are used interchangeably to refer to a “thin film”. For example, terms such as “PP film” or “PP layer” were interchangeably used depending on the description.

The plasticizer of the present disclosure may be completely removed from CA or partially remain in CA after the water pressure treatment, in which case the presence or absence of the plasticizer after the water pressure treatment is determined depending on whether the plasticizer and CA are chemically bonded. For example, CaO partially remains in the CA film layer even after the water pressure treatment, while lactic acid is removed. In the present disclosure, the plasticizer plays a role in weakening the bonding strength of the CA chains so that pores are formed in spaces between the CA chains during the water pressure treatment. Despite being removed when forming the pores through the water pressure treatment, the plasticizer may partially remain in the CA film depending on the component thereof due to the strong interaction with CA.

Various chemicals capable of allowing the CA layer to have a plasticizing effect are usable as the plasticizer of the present disclosure, and examples thereof may include glycerin, lactic acid, CaO, glycolic acid, NaCl, NaNO₃, and propylene glycol. However, the plasticizer in the present disclosure is not specifically limited in type. In the present disclosure, specific plasticizer components are not limited as long as the bonding strength of the CA chains is weakened such that the pores are formed in the CA chains weakened by the water pressure treatment.

In the present disclosure, the water pressure during the water pressure treatment may be in the range of 2 to 20 bar, but the pressure may increase or decrease within the above range depending on the type of plasticizer, the desired pore size, and the like.

In the mixed solution, the plasticizer may be mixed in an amount in the range of 0.001 to 0.3 moles with respect to 1 mole of CA. The amount of the plasticizer may increase or decrease within the above range depending on the component of the plasticizer.

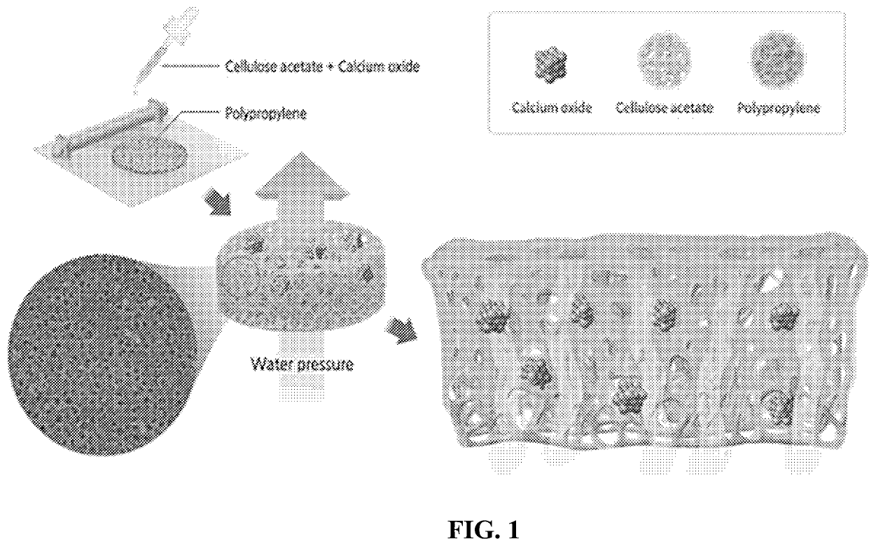

FIG. 1 is a schematic view illustrating the method of manufacturing the PP/CA-CaO separator of the present disclosure in the case of using CaO as the plasticizer. In the present disclosure, a PP film with already formed pores is fixed on a glass substrate. Then, an upper portion of the PP film is coated with a mixed solution of CA and CaO and then dried, thereby manufacturing a double-layer PP/CA-CaO separator. Furthermore, in the present disclosure, an upper portion of the double-layer PP/CA-CaO separator may be coated once more with the mixed solution of CA and CaO and then dried, which may be additionally coated third and fourth times as needed. In the present disclosure, the water pressure is applied in a direction from the PP side of the PP/CA-CaO double-layer separator to CA-CaO. The water pressure is transferred to the CA-CaO film by the water pressure treatment through the pores of the PP film with the already formed pores, thereby forming pores in the CA-CaO film by the water pressure. In particular, the water pressure is transferred to the CA-CaO film along the pores of the PP film, so pores connected to the pores of the PP are naturally formed in the CA-CaO film as well. As described above, CaO acts as the plasticizer to loosen the chain linkages between the CA chains so that the pores are formed in the CA film. Additionally, the CA chains weakened by CaO are formed into pores connected to the pores of the PP film by the water pressure, thus forming a nearly straight pore channel penetrating the PP and CA films.

The present disclosure will be described in more detail hereinbelow through experimental results of different plasticizers.

### Experimental Example 1: PP/CA-Lactic Acid Separator

A method of manufacturing a separator by bonding an eco-friendly and low-cost CA film to a PP film is proposed in this experiment.

### 1-1) Manufacture of “PP/CA-Lactic Acid” Separator

In this experiment, CA (molecular weight (Mw)=30000, Sigma-Aldrich), lactic acid (Daejung Chemicals), and acetone (Daejung Chemicals) were used. In this experiment, a PP film (having a pore size of 200 nm, GVS) was used as a polymeric support. All materials in this experiment were purchased and used without additional treatment. In this experiment, CA was dissolved in a mixed solvent of H₂O and acetone in a weight ratio of 2:8 to prepare a 10 wt % CA mixed solution. A CA-lactic acid mixed solution was prepared by adding lactic acid to the CA solution so that a molar ratio of CA to lactic acid became 1:0.07 and then stirred at room temperature for 4 hours.

The PP film with already formed pores (having a pore size of 200 nm) was fixed on a glass plate. An upper portion of the PP film was coated with the CA-lactic acid mixed solution to a thickness of 300 μm using a doctor blade and then dried. An upper portion of the primarily coated PP film was coated with the CA-lactic acid solution once more and then dried, meaning that the upper portion of the PP film was coated with the CA-lactic acid solution a total of two times. The resulting PP/CA-lactic acid film was subjected to water pressure in water treatment equipment, allowing the water pressure to be applied in a direction from the PP film to the CA-lactic acid film. The water pressure applied started at 2 bar and increased to 8 bar. Water flux was also measured during the water pressure treatment.

### 1-2) SEM

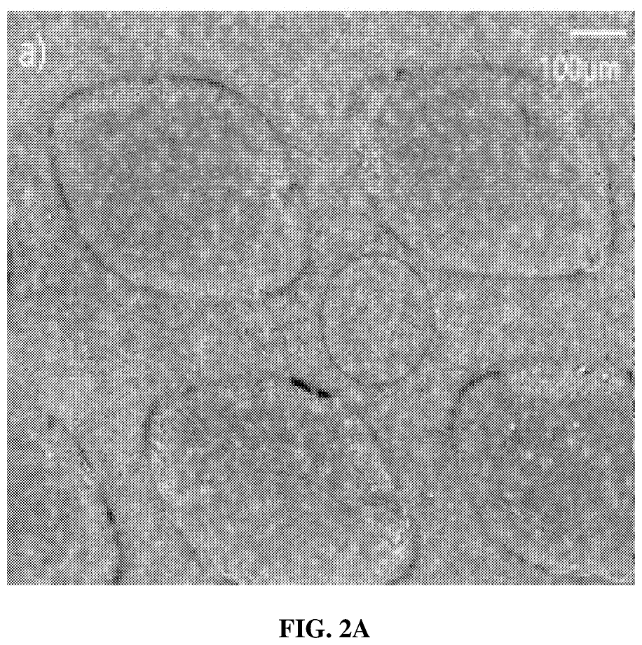

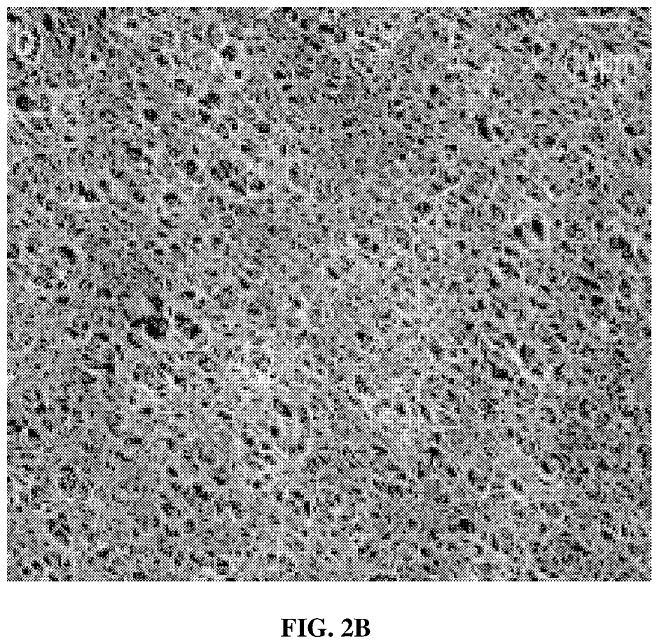

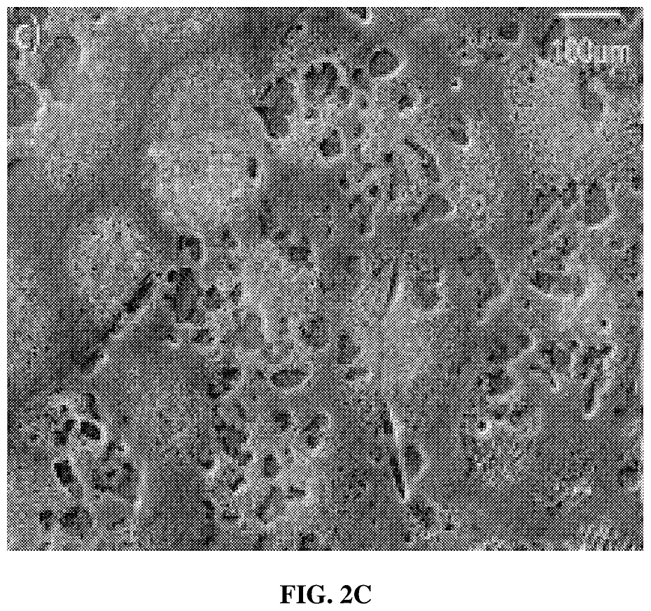

FIG. 2A is an SEM measurement image of the PP-side surface of the PP/CA-lactic acid separator, confirming that sponge-shaped pores were formed. FIG. 2B is an enlarged view of the circle in FIG. 2A, in which the white area indicates the portion of PP affected by CA.

FIG. 2C is an SEM measurement image of the CA-side surface of the PP/CA-lactic acid film, and FIG. 2D is an enlarged view of the circle in FIG. 2C, in which the white area is where CA is plasticized by lactic acid. Many pores were observed in the plasticized area. In other words, a portion of CA weakened by lactic acid was formed into pores by the water pressure treatment. The average pore size was 1 μm or smaller.

FIG. 2E is a cross-sectional SEM measurement image of the PP/CA-lactic acid separator. The upper portion corresponds to the cross section of the CA film, and the lower portion corresponds to the cross section of the PP film. Separation was not observed at the interface between CA and PP, confirming that the PP film and the CA-lactic acid film were well-bonded. It was seen that the physical strength of the PP/CA-lactic acid separator was stronger than that of each film alone because both films were well-bonded.

### 1-3) FT-IR

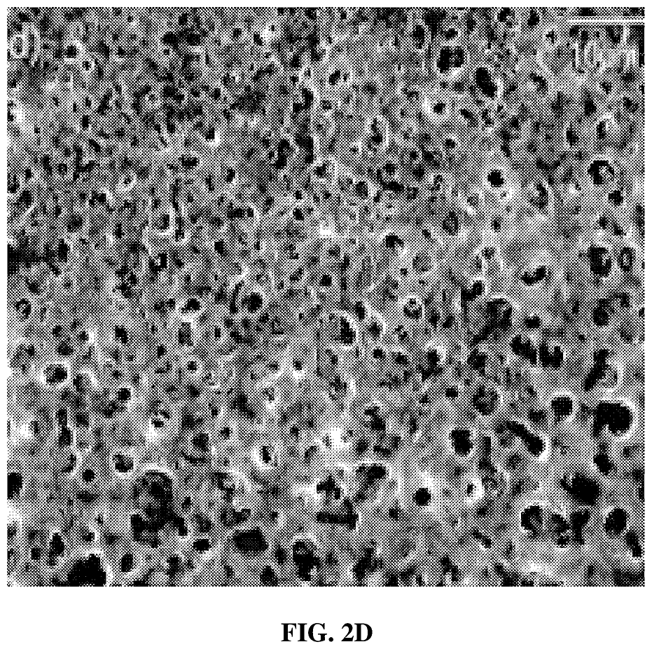

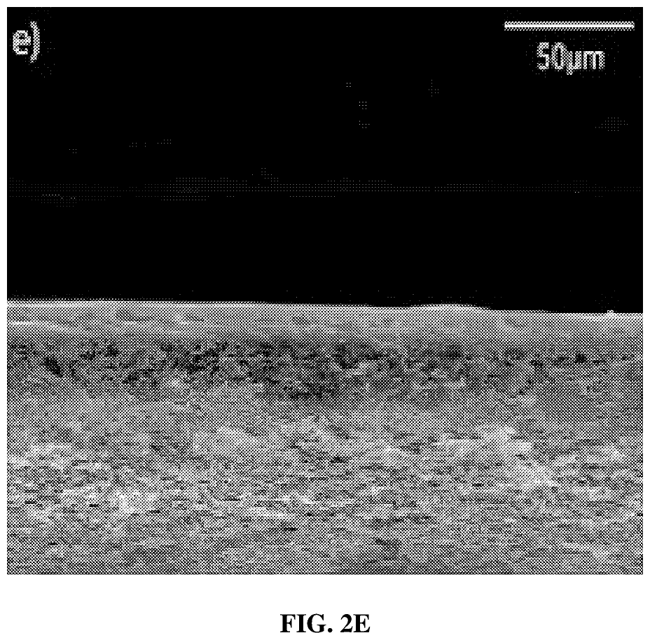

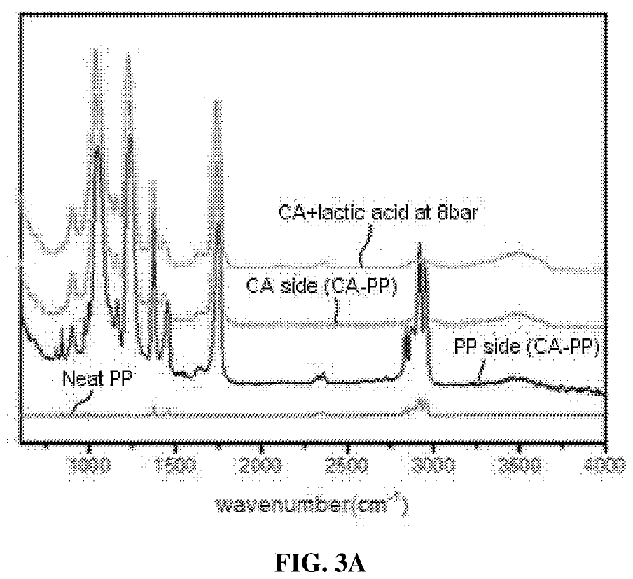

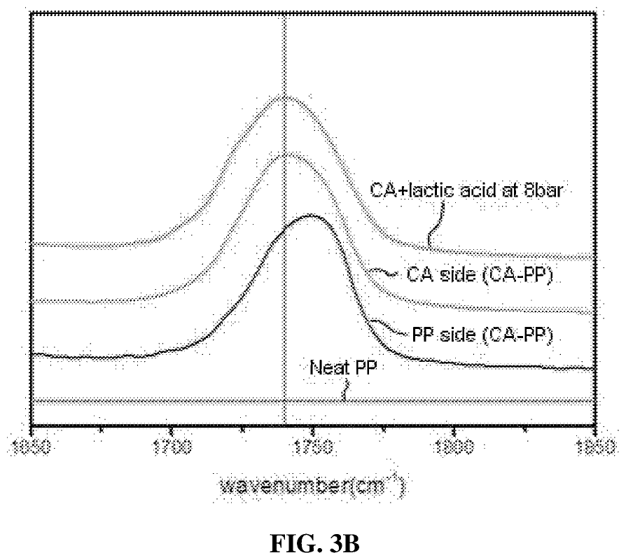

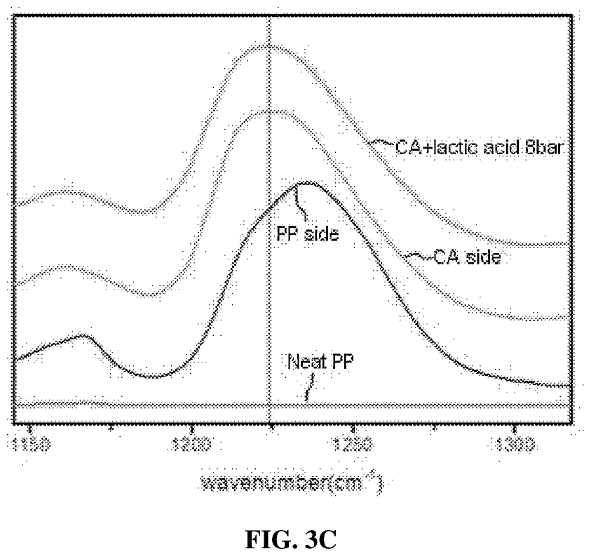

FIGS. 3A to 3C show FT-IR experimental results for separators of the present disclosure and comparative examples.

The FT-IR experiments on the PP/CA-lactic acid separator were used to validate the interaction between CA and PP. The FT-IR experiments were performed on the CA-lactic acid film, the PP/CA-lactic acid composite film, and neat PP. Except for the neat PP film, the other two films were subjected to water pressure treatment at 8 bar and then dried in a vacuum oven for two days.

Referring to FIGS. 3A and 3B (in the range of 1650 to 1850 cm⁻¹), the interaction between PP and the C═O group (carbonyl group) of CA is confirmed at a wavenumber of 1750 cm⁻¹. From the result of the FT-IR on the CA side of the PP/CA-lactic acid separator and the CA-lactic acid film (CA+lactic acid at 8 bar), there was no difference in the C═O band. On the other hand, a gap between the C═O bands of the PP side of PP/CA-CaO and neat PP was significant. As a matter of course, no C═O band was observed in the case of the neat PP film. However, a C═O band was confirmed at a wavenumber of 1750 cm⁻¹ in the measurement on the PP side of the PP/CA-lactic acid separator. Additionally, the C═O band of the PP side of the PP/CA-lactic acid separator was observed at a higher wavenumber than that in the case of the C═O band of the CA side of the PP/CA-CaO separator. The above result may be interpreted that the C═O peak is observed at a higher wavenumber on the PP side because the CA-lactic acid bond is weakened while the PP-side bond is strengthened. From the above FT-IR experimental results, it was seen that the CA-CaO film was well-bonded to the PP film.

From FIG. 3C, whether the C—O—C group of CA and PP interacted at a wavenumber of 1250 cm⁻¹ was confirmed. In the case of the neat PP film, no peak was observed at a wavenumber of 1250 cm⁻¹, indicating a C—O bond, while in the case of the PP side of PP/CA-lactic acid, a C—O bond in a profile similar to that in the case of the CA side was observed. However, the C—O bond measurement results showed a shift to a higher wavenumber in the case of the PP side than that in the case of the CA side of PP/CA-lactic acid. The above FT-IR results indicate that the bond between the CA-lactic acid film and the PP film is strengthened.

### 1-4) TGA

The thermal stability of the separators was confirmed by measuring the decomposition temperature of each film through TGA experiments. Like the above FT-IR experiments, the TGA experiments were conducted after subjecting the films other than the neat PP film to water treatment and then drying for two days.

As a result of the TGA experiments, neat PP started to decompose at a temperature of 410° C. and decomposed completely from a temperature of 450° C. The CA-lactic acid film started to decompose at a temperature of about 275° C. and decomposed mostly at a temperature of about 380° C.

The PP/CA-lactic acid separator of the present disclosure started to decompose within a range similar to that in the case of the CA-lactic acid film. In the PP/CA-lactic acid separator, a small amount of lactic acid remained in the CA film layer and acted to make the CA chains flexible (=plasticized). In the PP/CA-lactic acid separator, PP started to compose at a temperature in the range of 350° C. to 400° C. and decomposed mostly at a temperature of 450° C.

The thermal decomposition temperature of the CA film is lower than that of the PP film, but the melting temperature of CA is higher than that of PP. While the melting temperature of CA is in the range of 230° C. to 300° C., the melting temperature of PP is 160° C., so the CA film still does not melt even when PP melts at a relatively lower temperature. This allows the separator to remain at a relatively higher temperature than in the case of neat PP, thus protecting a battery from electrode shorts up to higher temperatures.

### Experimental Example 2: PP/CA-Glycerin Separator

### 2-1) Manufacture of PP/CA-Glycerin Separator

Experiments were conducted by purchasing CA (having an Mw of 30000) from Sigma-Aldrich and purchasing lactic acid and acetone from Daejung Chemicals. A PP film (having a pore size diameter of 100 nm, a diameter of 90 mm, and a thickness of 110 μm) was purchased from GVS for use.

As a solvent, a mixed solvent of acetone and distilled water in a mass ratio of 8:2 was used. CA and glycerin were mixed in the mixed solvent in a molar ratio of 1:0.05 to prepare a 10 wt % CA-glycerin mixed solution. The mixed solution was mixed at a temperature of 25° C. and a humidity of 50% for 15 hours.

The PP film was placed on a glass plate and then coated with the CA-glycerin solution to a thickness of 300 μm using a doctor blade for 30 seconds for CA film coating. Next, the resulting PP/CA-glycerin film was dried in a constant temperature and humidity chamber for 20 minutes. The PP/CA-glycerin separator was subjected to water pressure treatment at 8 bar for 1.5 hours. After the entire water pressure treatment, pores penetrating the PP and CA-glycerin films were formed while strengthening the bond between the PP and CA films through the water pressure treatment.

### 2-2) SEM

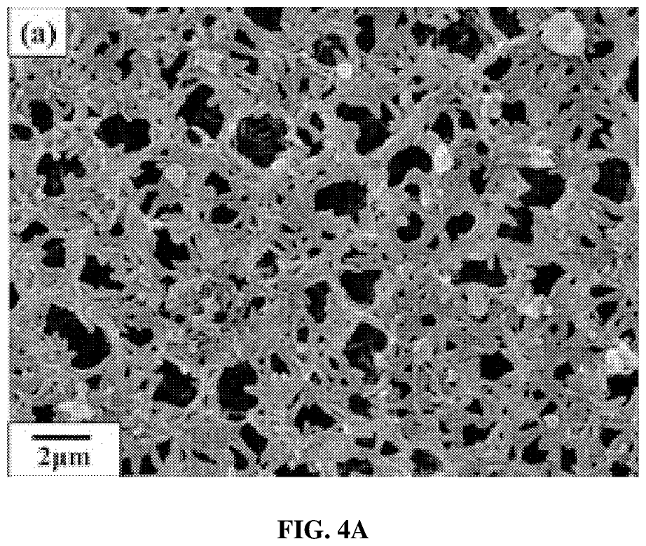

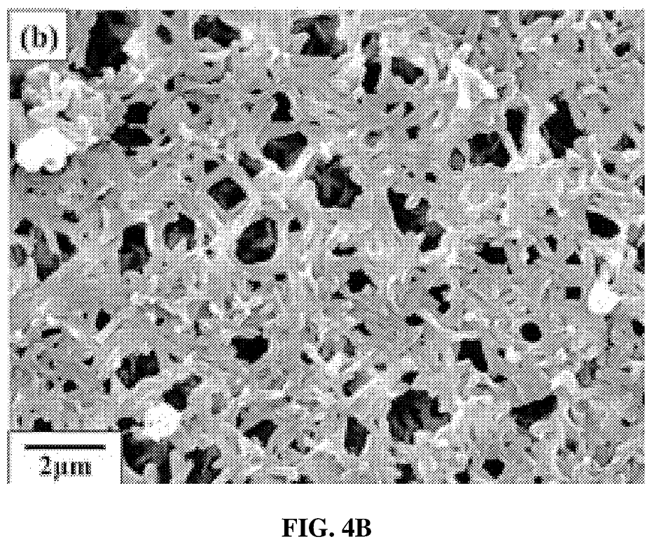

FIGS. 4A and 4B are SEM measurement images of a neat PP film and the PP side of the PP/CA-glycerin separator, respectively. Referring to FIG. 4A, small pores having a size of 100 to 200 nm and large pores having a size of 2 μm coexisted in the neat PP film. As shown in the result of FIG. 4B, there was no difference in the SEM measurement result for the PP side of PP/CA-glycerin, nor in the pore shape.

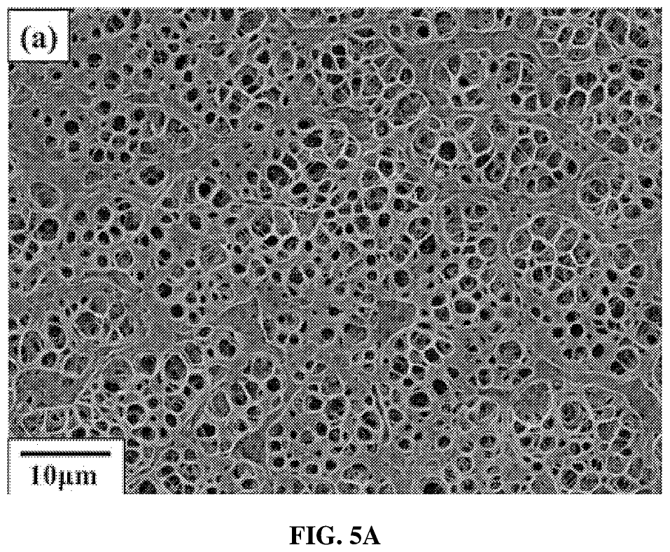

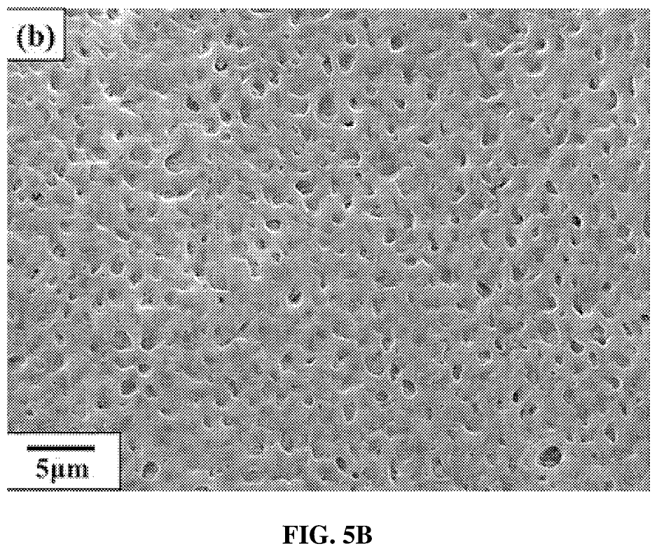

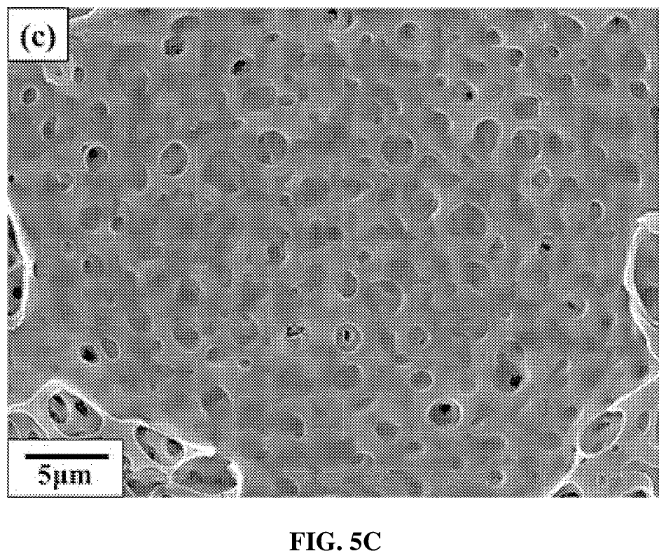

FIGS. 5A and 5B are SEM measurement images of the surface of the CA-glycerin film before and after water treatment, respectively, and FIG. 5C is an SEM measurement image of the CA side of the PP/CA-glycerin separator.

In the case of the sample (before water pressure treatment) dried after adding glycerin to CA, it was seen as shown in FIG. 5A that acetone and distilled water, serving as the co-solvents, were vaporized, and pore-shaped materials remained. FIG. 5B shows the CA-glycerin film (after water pressure treatment) subjected to water pressure treatment up to 8 bar from a state without involving water treatment in FIG. 5A, confirming that the upper side of the chains was slightly broken, and pores were thus formed inside. Additionally, in the case of the PP/CA-glycerin separator, channels with connected pores inside were formed by water pressure treatment at 8 bar, as shown in FIG. 5C.

### 2-3) TGA

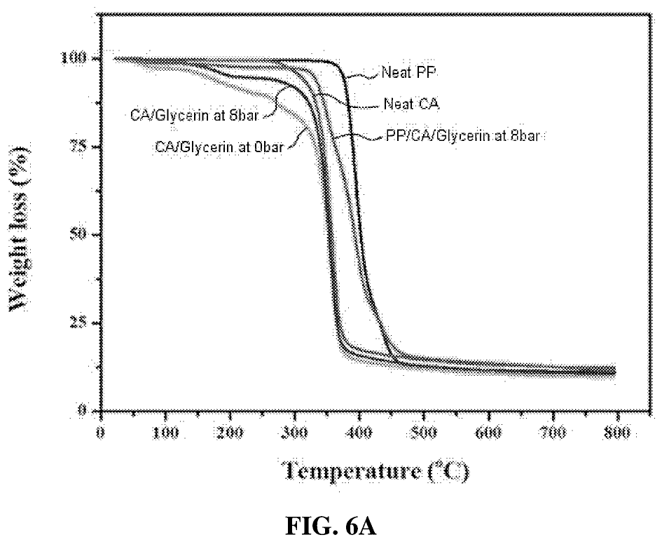

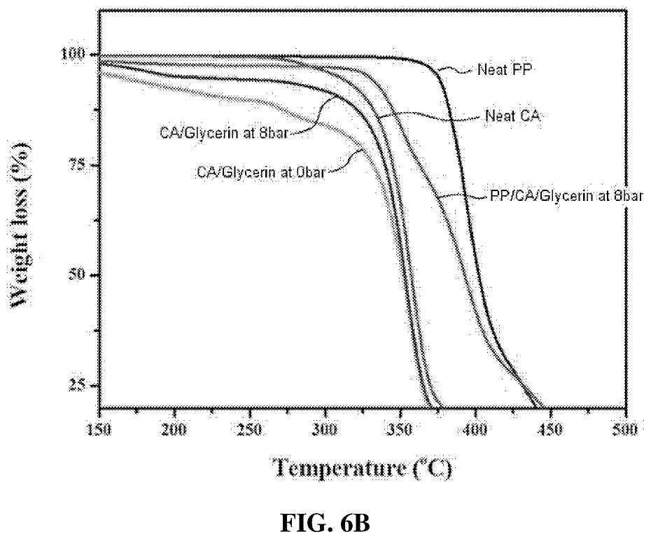

FIG. 6A shows TGA data on neat PP, neat CA, CA-glycerin (before water pressure treatment), CA-glycerin (water pressure treatment at 8 bar), and PP/CA-glycerin separator samples, and FIG. 6B is an enlarged view of FIG. 6A.

Analysis of the TGA data on each film showed that the thermal decomposition of neat CA and neat PP started at temperatures of 265° C. and 350° C., respectively. Due to the plasticizing effect of the OH group in glycerin, the CA-glycerin (at 0 bar) sample started to decompose at a temperature of 140° C. However, the CA-glycerin (at 8 bar) sample from which glycerin was removed by the water pressure treatment started to decompose at a temperature higher than 140° C. On the other hand, the PP/CA-glycerin separator started to decompose at a higher temperature (325° C.) than in the case of neat CA (265° C.). It was seen from the above results that the water pressure treatment strengthened the cross-linking of the CA and PP chains, thus strengthening the bond of the CA and PP layers.

### 2-4) FT-IR

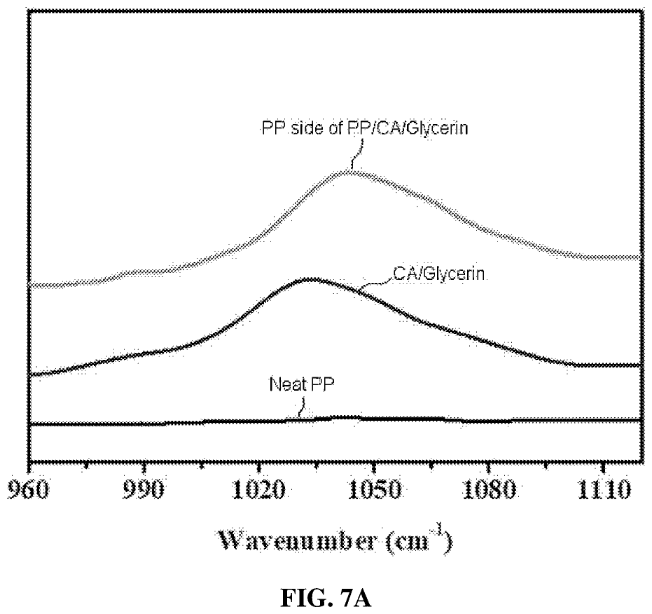

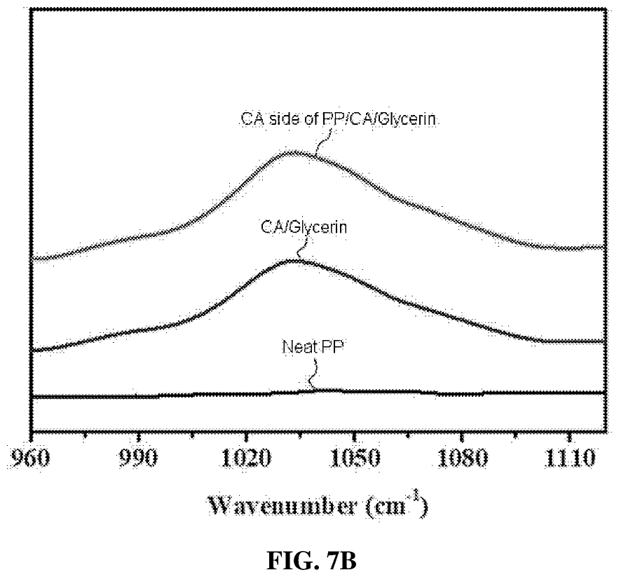

FIGS. 7A and 7B show FT-IR experimental results for C—O—C ether groups (in the range of 960 to 1100 cm⁻¹) of neat PP, the CA-glycerin film, and the PP/CA-glycerin separator. Referring to FIG. 7A, it was confirmed that the FT-IR analysis result of the ether group at a wavenumber in the range of 960 to 1100 cm⁻¹ on the PP side of the PP/CA-glycerin separator showed a higher wavenumber compared to that in the case of the CA-glycerin film. The above results may be interpreted that PP was well-coated with the CA-glycerin film, and a new interaction between PP film and CA-glycerin film affected the ether group.

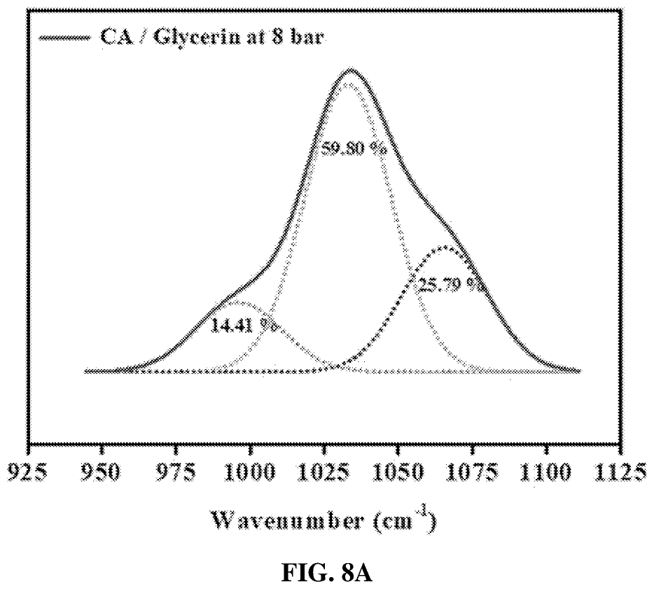

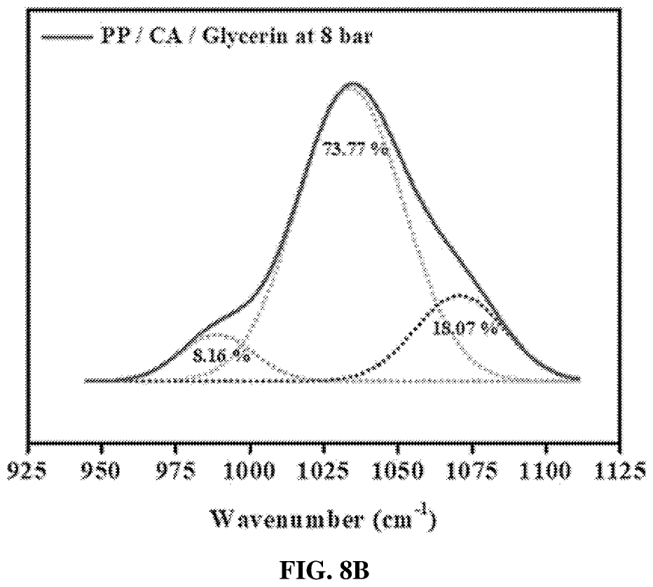

FIGS. 8A and 8B show deconvoluted data on FT-IR measurement results for the ether groups in the range of 960 to 1100 cm⁻¹) of CA-glycerin (water pressure treatment at 8 bar) and the PP/CA-glycerin (water pressure treatment at 8 bar) separator, respectively. The deconvolution results of the CA side showed that a peak at a wavenumber of 1034 cm⁻¹ tended to be more symmetrical in the case of the PP/CA-glycerin separator than in the case of the CA-glycerin film. These results may be interpreted as the ether group of CA having a new interaction with PP.

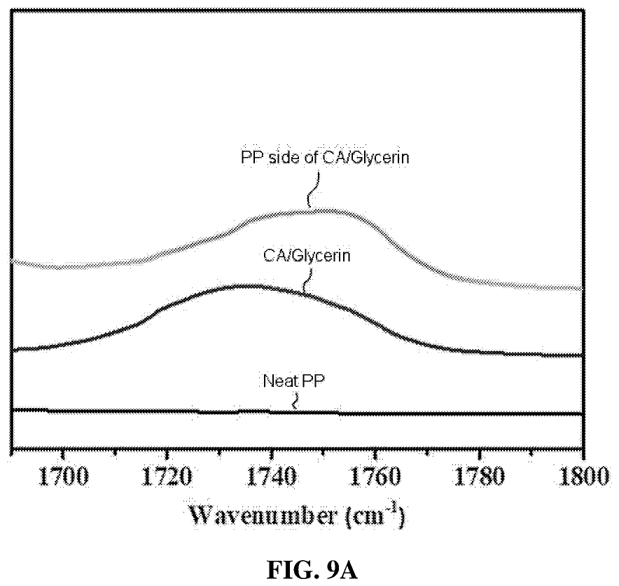

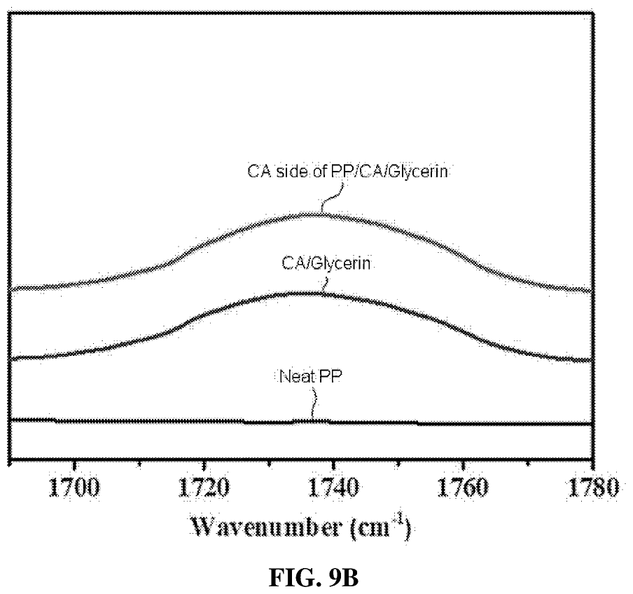

FIGS. 9A and 9B show FT-IR spectra for carbonyl groups (in the range of 1690 to 1780 cm⁻¹) of the neat PP, CA-glycerin, and the PP/CA-glycerin separator. The FT-IR results showed a shift of the carbonyl group measured on the PP side of the PP/CA-glycerin separator to a higher wavenumber than that in the case of the comparison samples (see FIG. 9A). This may be interpreted for the same reason as the above ether experimental results.

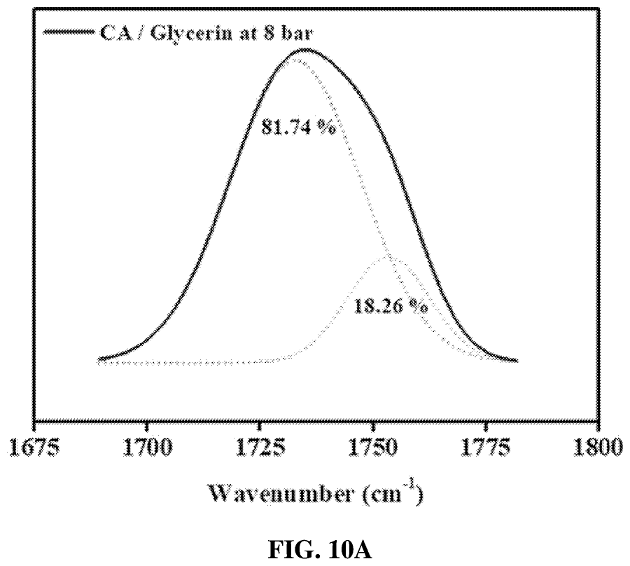

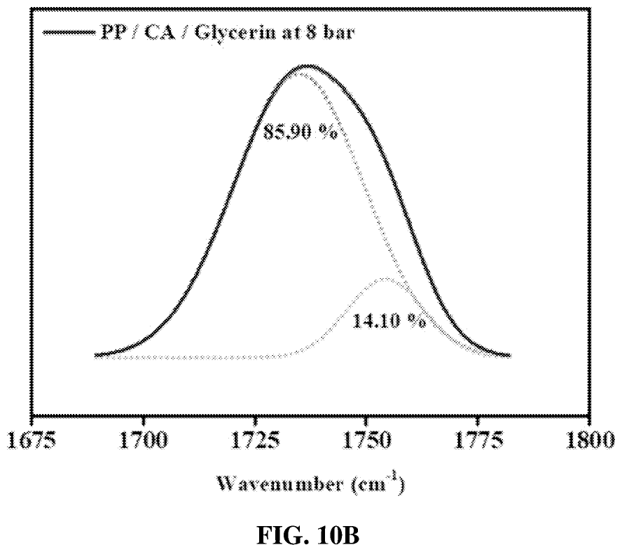

FIGS. 10A and 10B show deconvoluted data on FT-IR spectra for the carbonyl groups (in the range of 1690 to 1780 cm⁻¹) of CA-glycerin and the PP/CA-glycerin separator, respectively. The deconvolution results of the CA side of the PP/CA-glycerin separator showed a shift to a wavenumber lower by about 4.16% in the case of the PP/CA-glycerin separator compared to the case of CA-glycerin. This means that a new interaction between PP and CA occurred.

### Experimental Example 3: PP/CA-CaO Separator

### 3-1) Manufacture of PP/CA-CaO Separator

CaO (99.9%), N,N-dimethylformamide (DMF, 99.8%), CA (Mw=30000), acetone (99.8%), and a PP film (having an average pore size of 100 nm and a thickness of 110 μm) were purchased for use. CA was stirred in a mixed solvent of DMF and acetone, serving as co-solvents, in a weight ratio of 8:2 for two hours to prepare a 15 wt % CA solution. CaO was mixed in the above solution so that a molar ratio of CA to CaO became 1:0.006. The resulting mixed solution was stirred once more for 48 hours.

The PP film was fixed on a glass plate, and then an upper portion of the PP film was coated with the resulting CA-CaO solution to a thickness of 300 μm using a doctor blade. The resulting PP/CA-CaO separator was dried at a temperature of 25° C. and a humidity of 50% for 20 minutes. In this experiment, the separator was subjected to water pressure treatment at 8 bar for 3 hours. Data on the porosity of the separator are shown in the following table (the diameter and porosity of neat PP are also measured after water pressure treatment.

TABLE 1

| | | PP/CA and CaO |
|---|---|---|
| Sample | Neat PP | separator |

| | | | | |
|---|---|---|---|---|
| Average pore diameter | 352 | nm | 429 | nm |
| Bulk density | 0.37 | g/ml | 0.37 | g/ml |

| | | |
|---|---|---|
| Porosity | 62.9% | 68.8% |

While pores were formed in the separator by the physical force resulting from water pressure, the water pressure treatment was performed such that the water pressure was applied from the PP film side to the CA film side of the PP/CA-CaO separator. The average water flux obtained through a number of experiments was 208 L/m²h (LMH). Additionally, according to the results of a porosimeter, the porosity of the PP/CA-CaO separator was 68.8%. It was confirmed from the experimental results of the porosity and water flux that both film layers of PP and CA-CaO were physically well-bonded, and pores were formed in both films of PP and CA-CaO through the water pressure treatment. In the case of use in lithium-ion batteries, the separator of the present disclosure has a high porosity and water reflux, enabling high ionic conduction of lithium ions. This is because the pores in the separator of the present disclosure are straightly formed while penetrating the PP and CA-CaO films through the water pressure treatment. High-porosity separators are advantageous in that an increase in the surface area leads to an increase in wettability. In the case of MFCs, microbes may adhere to the surface of a separator and block pores, causing fouling. However, the separator of the present disclosure may prevent fouling by hydrophilicity. Thus, when applied to an MFC, the separator of the present disclosure is advantageous in that the performance of the MFC lasts for a long term.

### 3-2) SEM

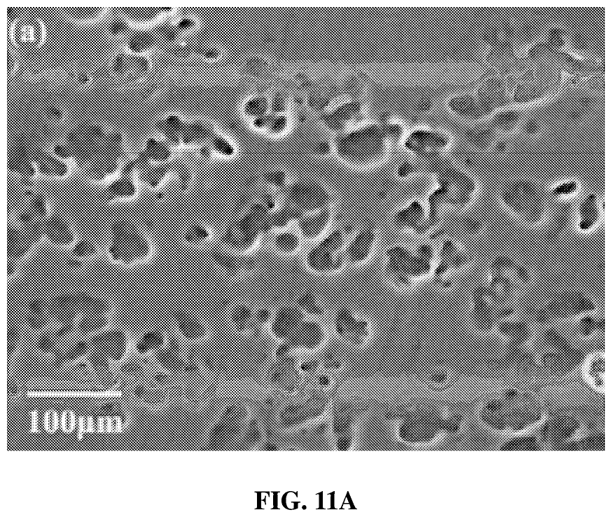

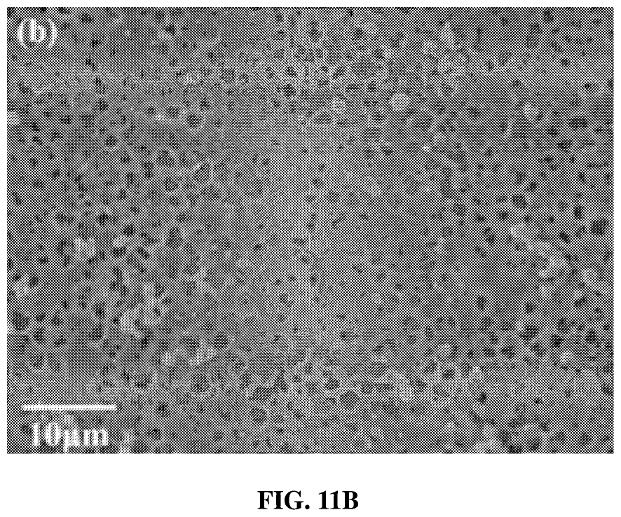

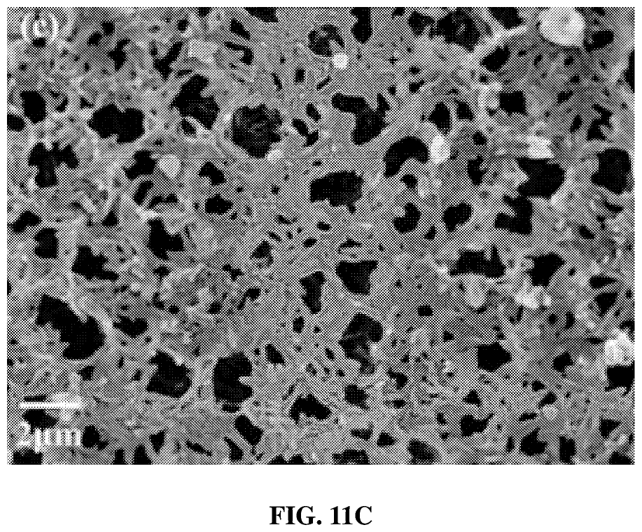

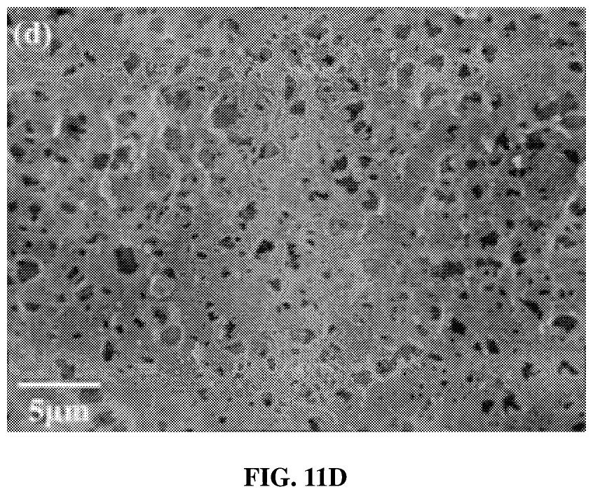

FIGS. 11A, 11B, 11C, and 11D show SEM measurement results of CA-CaO, the CA side of PP/CA-CaO, neat PP, and the PP side of PP/CA-CaO (all samples obtained through water treatment).

In the case of coating PP with the solution of CA and CaO, the mixed solution of Ca and CaO with the solvent permeates through the PP layer, thereby partially wrapping the PP chains. As shown in the SEM measurement result viewed from the CA side of PP/CA-CaO in FIG. 11B, pores were formed in the entire CA layer, and some pores were even blocked. When viewed from the PP side of the PP/CA-CaO separator as shown in FIG. 11D, pores were well-visible compared to FIG. 11B, and some pores were blocked by the remaining CA.

### 3-3) TGA

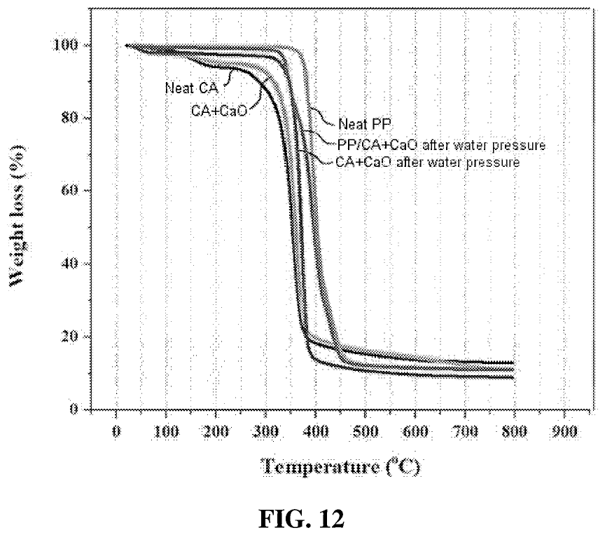

FIG. 12 shows TGA experimental results of neat PP, neat CA, CA-CaO (not involving water pressure treatment), CA-CaO (subjected to water pressure treatment), and PP/CA-CaO (subjected to water pressure treatment).

TGA experiments were conducted to confirm the thermal stability of the separators. The neat CA (solvent of DMF and acetone) started to decompose at a temperature of about 250° C. It was confirmed that the thermal stability of the CA-CaO sample (without involving water pressure treatment), to which CaO was added, slightly increased compared to that of neat CA. The CA-CaO (subjected to water pressure treatment) sample started to decompose at a temperature of 310° C., which increases by 60° C. or higher than the decomposition temperature of neat CA. Typically, in the case where an additive is dispersed between CA chains, the CA chains become flexible, and the additive has a plasticizing effect, resulting in weak thermal stability. However, a cross-linking effect is created in the CA chains in the case of adding CaO, as in the present disclosure. The cross-linking effect became even stronger after the water pressure treatment. It was seen that the PP/CA-CaO separator of the present disclosure started to decompose at a temperature of 310° C. and decomposed slowly.

From the above results, in the case of applying the separator of the present disclosure to a lithium-ion battery, the PP film layer melts first even when the lithium-ion battery is overheated, causing shutdown to block pores while exhibiting thermal stability up to high temperatures due to the CA layer. Thus, the battery fire may be delayed up to high temperatures by creating a positive effect of delaying the complete melting and collapse of the separator compared to the neat PP film.

### 3-4) FT-IR

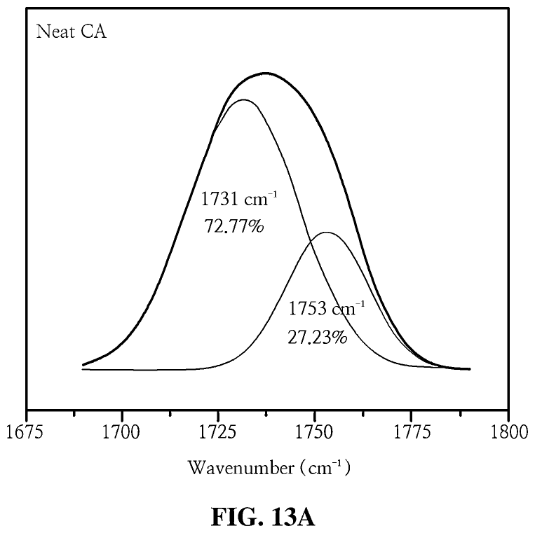

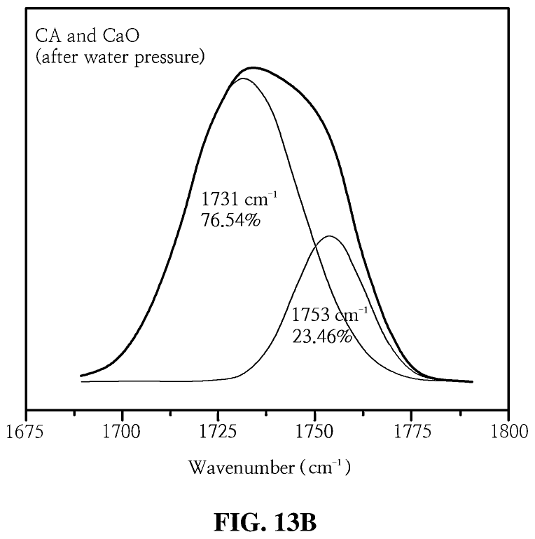

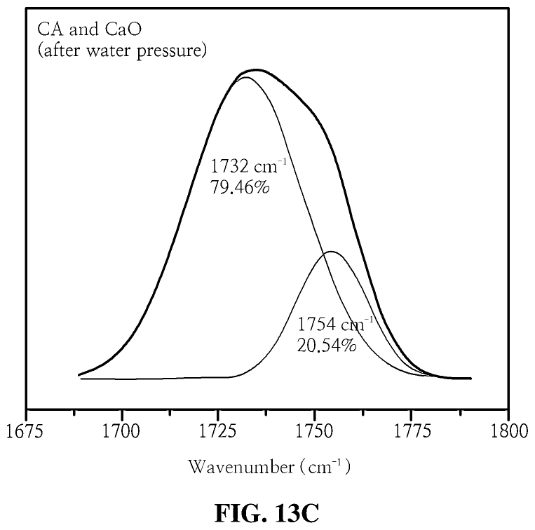

FIGS. 13A to 13C show FT-IR data on carbonyl groups for the neat CA, CA-CaO (before water pressure treatment), and CA-CaO (after water pressure treatment) samples, respectively. In the case of adding CaO to CA, the carbonyl group exhibited a shift to a lower wavenumber, followed by a shift to an even lower wavenumber after the water pressure treatment. This result is shown because the interaction between CaO and the carbonyl group is strengthened due to the remaining CaO even after the water pressure treatment. Compared to neat CA (FIG. 13A), when adding CaO and undergoing the water pressure treatment, the carbonyl group in the CA-CaO film exhibited a shift to a wavenumber lower by 6.7%, as shown in FIG. 13C. This result is shown because the increased mobility of the CA chains by the water pressure treatment leads to interaction with CaO.

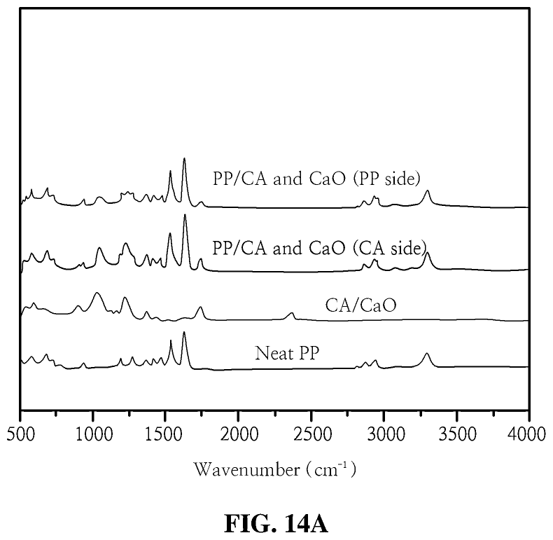

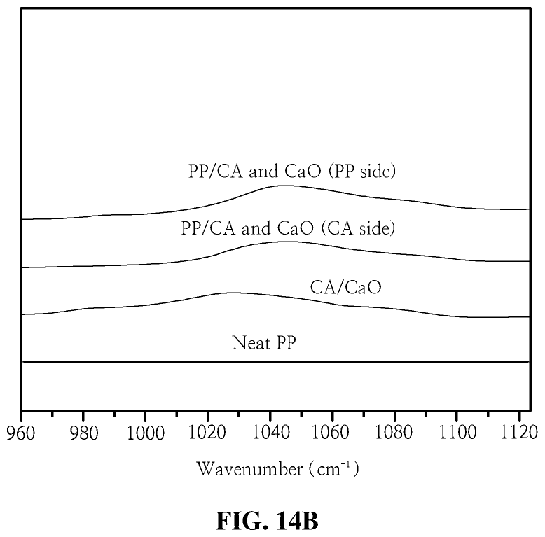

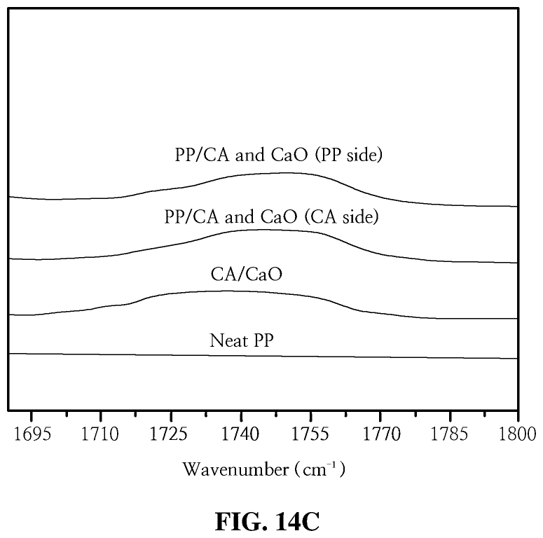

FIG. 14A shows FT-IR measurement results of different samples including PP/CA-CaO of the present disclosure, FIG. 14B is a partially enlarged view of ether groups (in the range of 960 to 1100 cm⁻¹), and FIG. 14C is an enlarged view of carbonyl groups (in the range of 1700 to 1800 cm⁻¹).

As a result of the measurements of the CA and PP sides of PP/CA-CaO, CA-CaO, and neat PP, gaps were shown depending on the samples in the ether groups (FIG. 14B) and carbonyl groups (FIG. 14C). Both ether and carbonyl groups exhibited shifts to higher wavenumbers in the case of the separator of the present disclosure compared to the CA-CaO sample subjected to the water pressure treatment.

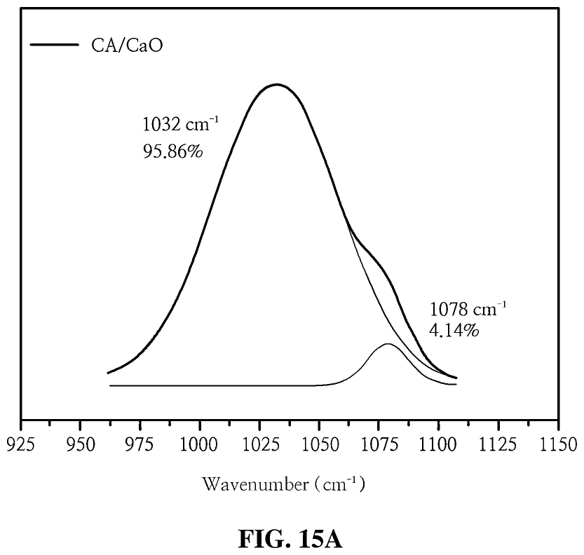

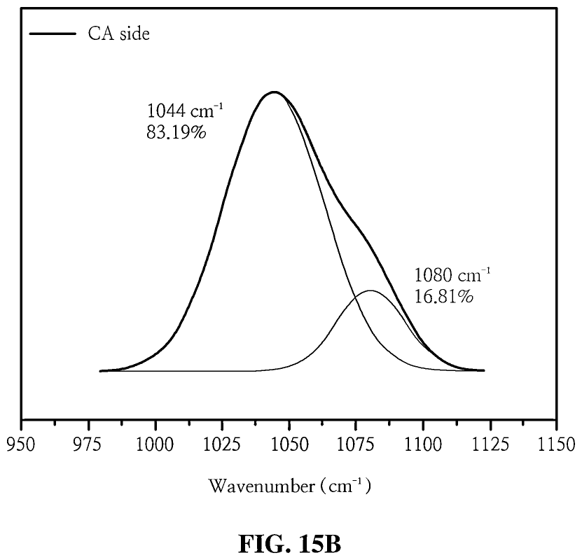

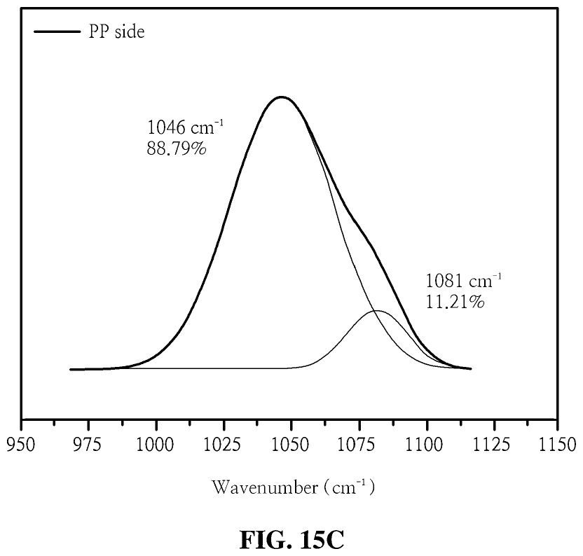

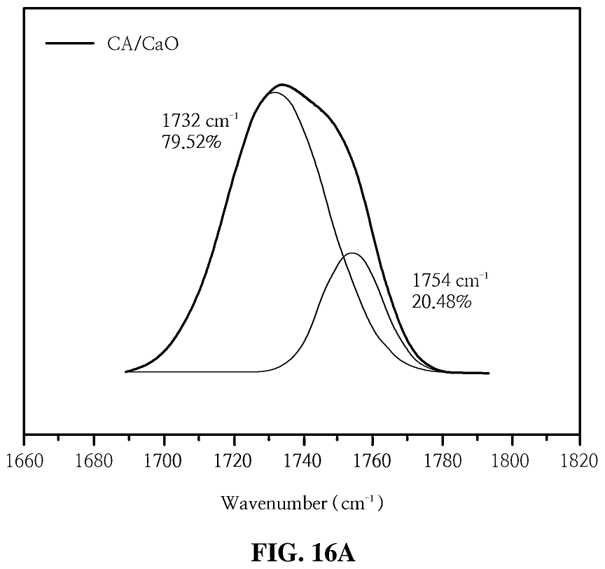

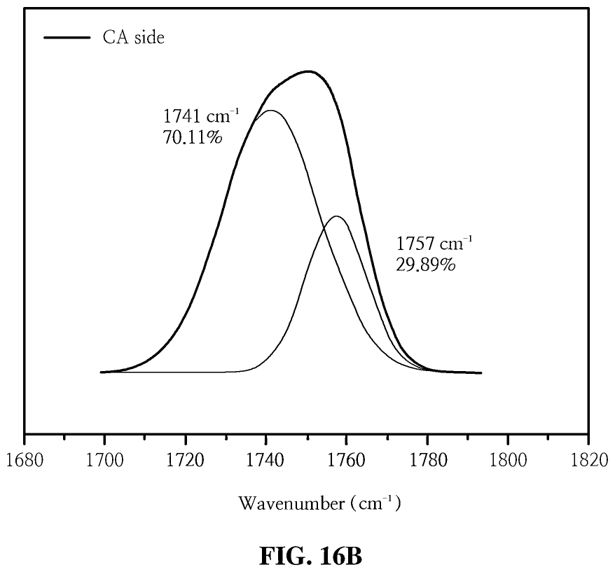

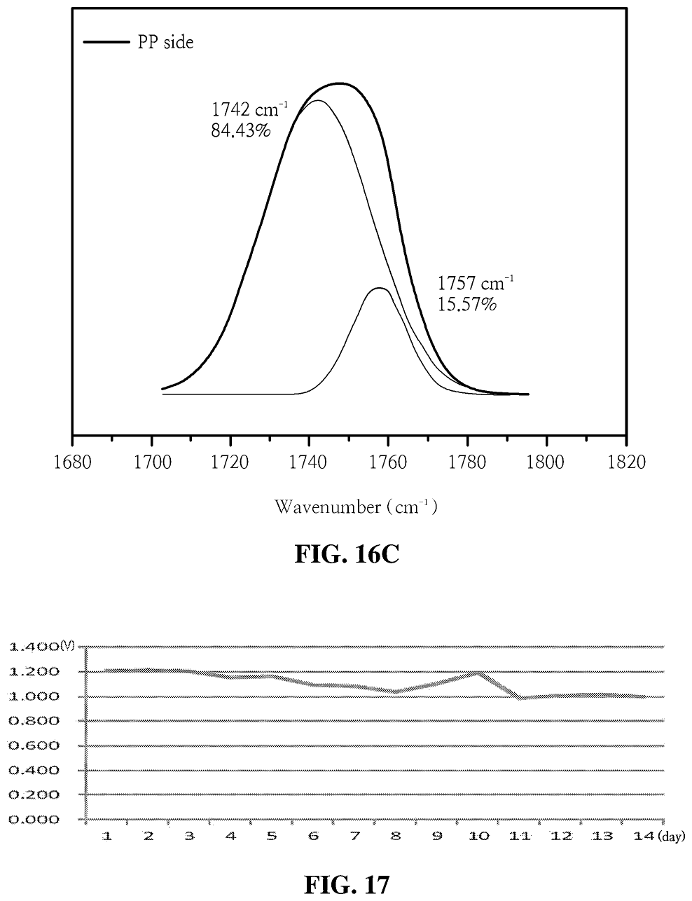

FIGS. 15A, 15B, and 15C show deconvoluted data on the ether groups of CA-CaO, the CA side of PP/CA-CaO, and the PP side of PP/CA-CaO, respectively, and FIGS. 16A, 16B, and 16C show deconvoluted data on the carbonyl groups of CA-CaO, the CA side of PP/CA-CaO, and the PP side of PP/CA-CaO, respectively.

The ether group of the CA-CaO sample exhibited a main peak at a wavenumber of 1032 cm⁻¹. However, this main peak shifted to wavenumbers of 1044 cm⁻¹ (FIG. 15B) and 1046 cm⁻¹ (FIG. 15C) in the measurement results of the CA and PP sides of the separator of the present disclosure, respectively. In the case of the carbonyl group, the main peak of CA-CaO appeared at a wavenumber of 1732 cm⁻¹ but shifted to wavenumbers of 1741 cm⁻¹ (FIG. 16B) and 1742 cm⁻¹ (FIG. 16C) in the measurement results of the CA and PP sides of the separator of the present disclosure, respectively. This is because the mixed solution of CA and CaO infiltrates into the PP chains and deteriorates the intermolecular bond of the PP chains. Both PP and CA molecules have strong intermolecular bonds, so each polymer chain is well-packed. However, it was seen that the CA-CaO solution infiltrated into the PP chains to keep the polymer from packing, thus weakening the existing bonds and forming new bonds.

### Example 4: MFC Application Experiment

### 4-1) Experimental Method

This experiment was conducted on a microbial fuel cell (MFC) to which the separator of the present disclosure was applied. An anode was fed 30 cc of an organic material every three days to decompose and oxidize anaerobic microbes, while a cathode operated without replenishment of an acceptor during the experimental period. A fuel cell composed of a two-compartment acrylic cell, with each compartment having a volume of 500 cc, for a microbial anode and a polymer receptor cathode, electrodes made of carbon sol, an anion exchange pore-filling separator, and the like were configured as the experimental equipment. As the separator, the PP/CA-CaO separator from Example 3 above was used.

### 4-2) Voltage

FIG. 17 shows voltage measurement results. The voltage of microbial incubation was measured at 0.05 V, which appeared to be at a level lower than the voltage of microbes measured at 0.3 in previous experiments. Such a result is attributable to microbial changes. There was a case in another experiment using microbes similar in type to those in this experiment where an open-circuit voltage of 0.6 V was recorded. Thus, the analysis suggests that there is a lot of room for the voltage to increase, depending on the microbial composition.

As shown below, the MFC shows a voltage, measured after starting the discharge experiment, converging to 1 V within a range of 1.206 V to 0.9 V, while being continuously discharged for three months. In particular, the discharge duration showed a significant gap from previous experiments. In the experiment using a conventionally available separator, the voltage started at 1.45 V, continuously decreased, and dropped to less than 0.8 V after ten days, leading to a pause in the discharge experiment. However, the MFC of the present disclosure showed relatively uniform voltage for three months. Being continuously discharged without exchanging electrolytes serves as an indicator to determine the economic viability of fuel cells, thus leading to the expectation that the application of the separator of the present disclosure will make progress in the commercialization of cells in future.

1. A method of manufacturing a polypropylene (PP)/cellulose acetate (CA) separator having a double-layer structure and comprising a PP film and a CA film, the method comprising:
preparing a porous PP film;
manufacturing a PP/CA separator by coating and drying an upper portion of the porous PP film with a mixed solution comprising CA, a plasticizer, and a solvent at least once; and
forming a pore channel penetrating layers of the PP and CA films by applying water pressure to the PP/CA separator through water pressure treatment.

2. The method of claim 1, wherein the plasticizer is at least one selected from among glycerin, lactic acid, CaO, glycolic acid, NaCl, NaNO₃, and propylene glycol.

3. The method of claim 1, wherein the mixed solution comprising CA and the plasticizer is a solution in which CA and the plasticizer are mixed in a molar ratio in a range of 1:0.001 to 0.3.

4. The method of claim 1, wherein the solvent is a mixture of two or more solvents.

5. The method of claim 1, wherein the water pressure treatment is performed such that the water pressure is applied in a direction from the PP layer to the CA layer.

6. The method of claim 1, wherein the water pressure is in a range of 2 to 20 bar.

7. A battery to which the separator of claim 1 is applied.

8. The battery of claim 7, wherein the battery is a microbial fuel cell (MFC).
